(19) United States
(12) Patent Application Publication
(10) Pub. No.: US 2010/0161520 A1
(43) Pub. Date: Jun. 24, 2010

(54) COMPRESSED TEXTILES TECHNOLOGY AND METHOD OF USING SAME

(76) Inventors: JONATHAN G. SHAVEL, Princeton, NJ (US); DOUGLAS E. SHAVEL, LAWRENCEVILLE, NJ (US)

Correspondence Address: Powers Law Firm, 1484 Pollard Road , Suite 162, Los Gatos, CA, 95032, US

(21) Appl. No.: 12/640,982

(22) Filed: Dec. 17, 2009

Related U.S. Application Data
(60) Provisional application No. 61/140,614, filed on Dec. 23, 2008.

(51) Int. Cl. B32B 1/06; G06Q 90/00

(52) U.S. Cl. 705/500; 428/35.5

(57) ABSTRACT

The present invention comprises a home textile product having an outer textile shell with a polyester fiber blend disposed therewithin. The fiber blend is characterized by substantially complete rebound following compression, and comprises a blend of a first 0.7-0.9 microdenier polyester staple and a 12-17 denier second polyester fill, preferably in a blend of about 70% microdenier staple to about 30% polyester fiber fill.

### RELATED APPLICATION

This application claims priority to the following U.S. Provisional patent application: U.S. Ser. No. 61/140,614, filed Dec. 23, 2008, incorporated herein fully by reference.

### FIELD OF THE INVENTION

The present invention relates generally to synthetic blend fill material useful for construction of home textile products, such as bedding material, and relates specifically to synthetic blend fill material that is compressible packaging bedding that substantially regains bedding loft post-compression.

### BACKGROUND

In the current economy, manufacturing activities for various products often are performed outside the home country. In the United States, much manufacturing activity is handled in China, the Philippines, India, and the like. This is true of home textile manufacturing, such as the manufacture of bed and decorative pillows, comforters, duvet, mattress pads, feather beds, and the like. In the field of home textile manufacturing, such products are filled with feathers, polyester, blended materials, and the like at the overseas manufacturing facility to save on the costs of manufacturing. However, the cost of transporting these finished goods can be expensive due to their bulkiness—high loft products are limited in the amount of compression the material can withstand and, more importantly do not fully return to the pre-compressed loft.

Over the decades, much research and work has been done in the field of textile manufacturing to devise improved filler materials, casing materials, construction techniques, manufacturing techniques and equipment, and packaging techniques and materials to improve certain qualities of the resulting products and to reduce shipping costs. Currently, home textile products are filled with natural products, such as down feathers, silk, cotton and the like or the fill is manufactured from man-made materials, such as polyester, and blends of waste textiles, acrylic, or nylon. None of these materials provide the resilience and properties necessary for the product to return to essentially its pre-compression loft and shape.

Microdenier fibers have been used in the manufacture of various fabrics and home products. These fibers typically are woven into light weight, water repellent fabrics. They tend to be moisture vapor permeable due to their dense, compact fabric structure, yet have a soft “down-like” feel often used for filling bed pillows. By definition, microdenier yarns are composed of filaments having 0.5−1.5 denier per filament in size, resulting in ultra-fine, soft fabrics. Microdenier fibers are twice as fine as silk, three times finer than cotton, and eight times finer than wool, which makes products manufactured from this material soft, lightweight, and permeable. However, as a fiber it is not resilient when compressed. It loses most of its loft upon decompression when it is used as a fiber, which is why it primarily is used woven as a fabric.

Polyester has been used for decades in the manufacture of cloth and fill. Polyesters are polymers chemically composed of di-hydric alcohol and terephthalic acid. The resulting fiber is generally insoluble, shows resistance to weak concentrations of alkali (i.e., it is not affected by human sweat), and is durable. It is used primarily for the manufacture of fabrics rather than used as a loose fiber because, as with the microdenier fibers, it is not resilient when compressed. Once compressed, it does not regain substantially all of its original loft or shape.

Compression is essential in reducing the costs of manufacturing filled textile products. Because such products are filled, and because it is a desirous quality of filled textile products to have a predetermined loft and shape, it is important that the final product that reaches the consumer have the desired loft and shape. Various methods exist for compressing polyester filled home textiles, including mechanical compression and vacuum compression. However, all of the existing compression methods and filler materials result in a final, decompressed product with a reduced loft.

Thus, there remains a need for a home textile fill material that enables high compressibility of the material, while increasing the post-compression loft and shape resilience.

### SUMMARY OF THE INVENTION

The present invention comprises a home textile product having an outer textile shell with a polyester fiber blend disposed therewithin. The fiber blend is characterized by substantially complete rebound following compression. The fiber blend of the present invention is a blend of a first microdenier polyester staple and a second polyester fill. The first microdenier polyester staple of the present invention includes polyester fibers in the range of about 0.7 denier to 0.9 denier. The second polyester fill has includes polyester fibers in the range of about 12-17 denier. The blend of the present invention has a ratio of about 70% first polyester staple and about 30% second polyester fill.

In a method for using the inventive textile product, a home textile product having a first density is placed within an air impermeable flexible wrapper. The interior region of the wrapper then is evacuated, for example using vacuum compression, to define a second, compressed density of the textile product. The interior region is sealed and the wrapper is transported to the desired location. At the desired location, the interior region is unsealed and the textile product contained therewithin is returned substantially to its first density.

### BRIEF DESCRIPTION OF THE DRAWINGS

Various embodiments of the invention are disclosed in the following detailed description and the accompanying drawings.

FIG. 1 is a side elevation view of an exemplary home textile product of the present invention, in the form of a pillow,

FIG. 2 is a side elevation view of the home textile product of FIG. 1 in place for compression in accordance with the method of the invention.

FIG. 3B is a side elevation view of the home textile product of FIG. 1 following compression in accordance with the method of the invention.

### DETAILED DESCRIPTION OF THE INVENTION

The present invention relates to a range of home textile products that are filled with a material to give the products a desirable degree of loft and often a particular shape. Home textiles of the present invention include, by way of example, bed pillows, decorative pillows, duvet, mattress covers, featherbeds, comforters, quilts, chair and couch cushions, and similar decorative and functional textile products.

Each of these home textile products includes an outer textile shell defining an interior region that is filled with the blended polyester fiber fill of the present invention. The outer textile shell can be manufactured from any relatively flexible, formable, sheet material, such as cotton, silk, polyester, linen, and any number of woven fabrics generally commercially available. The outer textile shell essentially forms the space which is filled with the polyester fiber blend of the present invention, as described in further detail below. The entire filled product can be contained within a malleable, water and air impermeable, flexible wrapper material, such as sheet plastic, for purposes of packaging, storing, and transporting the product.

Filled products of the type of the present invention are designed to have a predetermined loft, or density and shape. The present invention is a microdenier fiber staple/polyester fiber fill blend that is highly compressible and which regains a significant amount of the original loft and shape post-compression.

In an embodiment of the invention, the novel polyester fiber fill is made of between about 65% to 75% microdenier polyester fibers (0.7-0.9 denier) and between about 25% to 35% polyester material of about between 12-17 denier. It is known in the art that the term “microdenier”, as it relates to synthetic fibers, refers to synthetic fibers with denier per filament (dpf) of between 0.5-1.5. Any of the generally commercially available microdenier polyester fibers may be used in manufacturing the fill of the invention. In a preferred embodiment of the invention, such products available from DA FA fiber company (Shanghai, China) are used. Other commercially available polyesters may be used from companies such INVISTA (DuPont) and Hoechst.

The microdenier fiber staple is blended with a 12-17 dpf polyester fiber to form the novel blended fiber fill. The preferred 12-17 dpf fibers typically are two-dimensional, being both hollow and ‘crimped’ for additional resilience. Such fibers are generally commercially available from a range of suppliers and manufacturers, both in the United States and abroad. Some manufacturers have their own brand of polyester fill in the desired 12-17 dpf range, which may be suitable blending material. In a preferred embodiment, DA FA Fibers (Shanghai, China) are used.

In a preferred embodiment of the blended polyester fiber fill of the present invention, the blend consists of 70% of 0.9 microdenier polyester fiber staple to 30% of 15 dpf polyester fiber fill. Each of the components is placed into a filling machine, such as a machine available from Shenzhen Pillow Machine Co., Ltd. The filler machine then blows the blend into the casing, or outer textile shell, of the desired home textile product. Different commercially available filler machines may be used, depending on the size of the textile product, the quantity of the manufacturing batches, and other factors unrelated to the invention.

In using the blended polyester fiber fill of the present invention, a casing is made into which the blend is blown to the desired density and shape. A wrapper, generally manufactured from plastic or other malleable material, then is used to contain the filled home product. The content of the wrapper then is vacuum compressed to an increased density, decreased size, suitable for shipping. The wrapper is sealed, and the entire contents are shipped to the desired destination. When the wrapper is opened and unsealed at the destination, the home textile product then takes in the air and “reconstitutes” upon introduction of air. The reconstitution or rebound of the product, including the internal fill material, returns the product to substantially the same loft and shape as it had pre-compression. As used herein the term “loft” has the customary meaning in the industry, specifically referring to the thickness of an item, such as a down comforter that is filled with a compressible material.

The following Table 1 shows the compression/decompression data, using the blend of 70% 0.9 microdenier polyester fiber staple/30% 15 dpf polyester fiber fill of the present invention for a 20/28 inch bed pillow:

TABLE 1

| Time | Pre-compression | Post-compression |
|---|---|---|
| (min.) | height (in.) | height (in.) |
| 1 | 16 inches | 13 inches |
| 5 | 16 inches | 13.5 |
| 15 | 16 inches | 14.5 |
| 30 | 16 inches | 15-15.5 |

Table 2 shows the compression/decompression data for a 20/28 inch bed pillow using the standard, commercially available polyester fill:

TABLE 2

| Time | Pre-compression | Post-compression |
|---|---|---|
| (min.) | height (in.) | height (in.) |
| 1 | 16 inches | 10 inches |
| 5 | 16 inches | 11.5 |
| 15 | 16 inches | 12 |
| 30 | 16 inches | 12-13 |

As shown in Tables 1-2, the degree of resilience or return to loft for the textile product using the blended polyester fiber fill of the present invention is significantly greater than the return to loft of the commercially available polyester fill material.

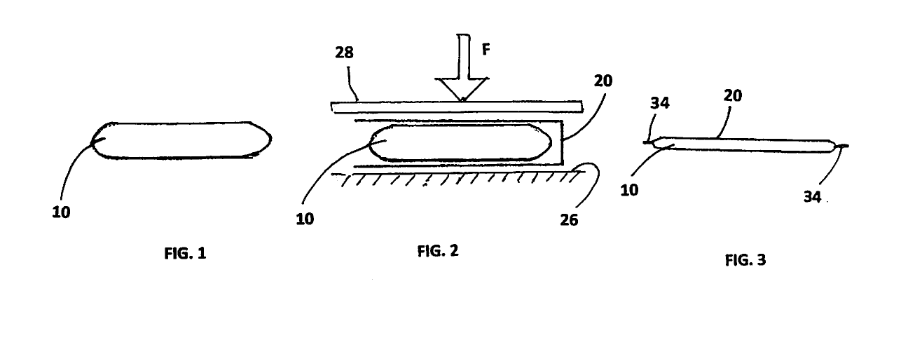

FIG. 1 shows an exemplary home textile products of the invention, in the form of a pillow 10. FIG. 2 shows the pillow 10 within a flexible, air impermeable open-ended bag 20 disposed within a base plate 26 and a compression plate 28. In accordance with the method of the invention, a force F is applied to compression plate 28 as illustrated in FIG. 2. In response to that force, the compression plate 28 is driven toward base plate 26, compressing the pillow 10 and its surrounding bag 20. Following compression, the open end of bag 20, is sealed for example by a conventional heat sealing device for a plastic bag. The resultant compressed pillow 10, within the sealed bag 20, is shown in FIG. 3, with the reference designations 34 indicating for pulse seals on the bag 20. The reduced volume of the compressed and bagged pillow 10 (as shown in FIG. 3), enables high density packaging of multiple similarly-bagged pillows for economical shipment. Following shipment to a retailing destination, or to a customer/user, the sealed bag 20 is opened, and the compressed pillow 20 resiliently expands to substantially the same volume as shown in FIG. 1.

It will be apparent to those skilled in the art that other changes and modifications can be made in the above-described invention and methods for making and using the same, without departing from the scope of the invention herein. It is intended that all matter contained in the above description shall be interpreted in an illustrative and not in a limiting sense.

What I claim is:

1. A home textile product comprising:
A. An outer textile shell defining an interior region, and
B. A polyester fiber fill blend disposed within said interior region, wherein said polyester fiber fill blend is characterized by substantially complete rebound following vacuum compression, said home textile product being characterized by a first loft prior to compression and a second loft in response to compression, wherein said first loft is greater than said second loft.

2. A home textile product according to claim 1, wherein said polyester fiber fill blend comprises a first 0.7-0.9 microdenier polyester staple and a second 12-17 denier polyester fill.

3. A home textile product according to claim 1, wherein said polyester fiber fill blend further comprises a 70-30% blend of the first microdenier polyester staple and the second polyester fill.

4. A home textile product according to claim 3, wherein said first microdenier polyester staple is 0.9 denier.

5. A home textile product according to claim 3, wherein said second polyester fill is 15 denier.

6. A home textile produce according to claim 1, wherein said first microdenier polyester staple is 0.9 denier and said second polyester fill is 15 denier.

7. A home textile product according to claim 1, wherein said product is a bed pillow.

8. A home textile product according to claim 1, wherein said product is a comforter.

9. A home textile product according to claim 1, wherein said product is a mattress pad.

10. A home textile product according to claim 1, wherein said product is a decorative pillow.

11. A home textile product according to claim 1, wherein said product is a featherbed.

12. A method for shipping one or more home textile product of claim 1 in an air impermeable flexible wrapper defining a reversably sealable interior region, comprising the steps of:
A. providing said wrapper, said interior region being unsealed;
B. placing said one or more home textile product in said interior region of said wrapper; and
C. evacuating said interior region of said wrapper, thereby compressing said one or more home textile product whereby said one or more home textile products are characterized by said second density;
D. sealing said interior region;
E. transporting said wrapper to a desired location; and
F. unsealing said interior region, whereby one or more home textile products rebound to substantially said first density.

13. The method of claim 12 comprising the further step of removing said one or more home textile product from said wrapper.
